(19) United States
(12) Patent Application Publication
(10) Pub. No.: US 2007/0175517 A1
(43) Pub. Date: Aug. 2, 2007

(54) Support for valve of inflatable bag

(76) Inventor: Teng-Hui Wu, Taipei City (TW)

Correspondence Address: BACON & THOMAS, PLLC, 625 SLATERS LANE, FOURTH FLOOR, ALEXANDRIA, VA, 22314, US

(21) Appl. No.: 11/344,132

(22) Filed: Feb. 1, 2006

(51) Int. Cl. F16K 15/20

(52) U.S. Cl. 137/231

(57) ABSTRACT

A support mountable in an inflatable bag having a belt shaped valve, comprises a tube shaped to partially fit into the belt shaped valve and including at least one first engagement member (e.g., groove or rib) formed on its outer surface; at least two clamp members each having an inner surface shaped to fit around the outer surface of the tube, each clamp member including a half flared support element extended from one end, and a second engagement member (e.g., rib or groove) formed on its inner surface wherein the second engagement members are securely engaged with the first engagement member for gripping a peripheral edge of the belt shaped valve; and a tubelike support member shaped to fit around outer surfaces of the clamp members for gripping the peripheral edge of the belt shaped valve by and between the clamp members and the tube.

### FIELD OF THE INVENTION

The present invention relates to inflatable bags (e.g., balloons) and more particularly to a support mounted in a belt shaped valve of an inflatable bag with improved characteristics.

### BACKGROUND OF THE INVENTION

A conventional inflatable bag adapted to be filled with air or a gas lighter than air is shown in FIG. 1. The inflatable bag comprises an airtight bag (e.g., balloon) 1 including two PE (polyethylene) films 10 and two nylon films 12 each bonded to an outer surface of the PE film 10. Some manufacturers of the inflatable bag may plate an aluminum layer 11 on an inner surface of the nylon film 12 prior to bonding the nylon film 12 to the outer surface of the PE film 10 for the sake of polishing the outer surfaces of the PE films 10 or making color printed on the nylon films 12 more vivid and colorful. Further, for facilitating filling air or gas into the inflatable bag a belt shaped valve 13 is airtightly formed on an edge portion of the inner surfaces of the PE films 10 by some manufacturers of the inflatable bag. The belt shaped valve 13 has one end extended a predetermined length inside the airtight bag 1 and the other end extended externally of the airtight bag 1 to serve as an inlet. The belt shaped valve 13 comprises two rectangular films 131 having its outer surface bonded to the airtight bag 1 by thermally pressing. As such, edges of the inner surfaces of the PE films 10 are bonded to corresponding portions of outer surfaces of rectangular films 131, resulting in an airtight state. Also, an ink area 14 is formed on corresponding portions of inner surfaces of the rectangular films 131 for preventing a flat passage for air or gas from being blocked. As a result, a user may blow air or pump air or gas into the airtight bag 1.

The rectangular films 131 of the belt shaped valve 13 are attached to each other. However, it may cause difficulties of blowing air into the airtight bag 1 for filling purpose. For overcoming this drawback, a user may first insert one end of an elongate tube 15 through the belt shaped valve 13 into the airtight bag 1. Next, the user may use his/her mouth or activate an air pump (not shown) to blow or pump air into the airtight bag 1 through the other end of the elongate tube 15. The user may pull the elongate tube 15 out of the belt shaped valve 13 after completing the filling of the airtight bag 1 (i.e., the airtight bag 1 is fully swelled). Thereafter, the rectangular films 131 of the belt shaped valve 13 are automatically bonded to the ink area 14 formed on the inner surfaces of the rectangular films 131 (i.e., the belt shaped valve 13 is closed) for preventing air filled in the airtight bag 1 from leaking.

However, a user may have great difficulties of blowing air into the airtight bag 1 due to adverse factors of the materials and structure of the airtight bag 1. In fact, it is impossible of blowing air into the airtight bag 1 to its full swell without the aid of the elongate tube 15. Moreover, it is not possible of maintaining the airtight bag 1 attached to a post on an upright position (i.e., floated obliquely) when the airtight bag 1 is fully swelled by pumping gas other than gas lighter than air (e.g., helium) due to increased weight of the airtight bag 1. This may not only contradict the purpose of being used as a decoration but also detract from its external appearance. Thus, it is desirable among manufacturers of the inflatable bag to provide a novel support for a valve of an inflatable bag in which the support is adapted to enable a user to easily blow air or pump air or gas into the inflatable bag, enable the user to hold and stably support the inflatable bag when it is swelled after the air or gas filling, and maintain in an upright position thereafter in order to overcome the inadequacies of the prior art.

### SUMMARY OF THE INVENTION

After considerable research and experimentation, a support for a valve of an inflatable bag according to the present invention has been devised so as to overcome the above drawback of the prior art. The support is adapted to enable a user to easily blow air or pump air or gas into the inflatable bag, enable the user to hold and stably support the inflatable bag when it is swelled after the air or gas filling, and maintain in an upright position thereafter.

It is an object of the present invention to provide a support mountable in an inflatable bag having a belt shaped valve, comprising a tube dimensioned and shaped to partially fit into the belt shaped valve of the inflatable bag, the tube including at least one first engagement member (e.g., groove or rib) formed on its outer surface; at least two clamp members each having an inner surface dimensioned and shaped to fit around the outer surface of the tube, each clamp member including a half flared support element extended from one end, and a second engagement member (e.g., rib or groove) formed on its inner surface wherein the second engagement members are securely engaged with the first engagement member for gripping a peripheral edge of the belt shaped valve when the inner surfaces of the clamp members are urged against the outer surface of the tube; and a tubelike support member dimensioned and shaped to fit around outer surfaces of the clamp members to grip the peripheral edge of the belt shaped valve by and between the clamp members and the tube.

It is another object of the present invention to after mounting the support in the belt shaped valve of the inflatable bag enable a user to lift the other ends of the clamp members distal the support member and easily blow air the inflatable bag after traveling through the support member, the tube, and the belt shaped valve.

It is a further object of the present invention to after inflating the inflatable bag enable the flared opening formed by the support elements to stably hold the inflatable bag such that the inflated inflatable bag will maintain in an upright position relative to the support when a user holds the support member.

The above and other objects, features and advantages of the present invention will become apparent from the following detailed description taken with the accompanying drawings.

### BRIEF DESCRIPTION OF THE DRAWINGS

FIG. 1 is a perspective view in part section of a valve portion of a conventional inflatable bag;

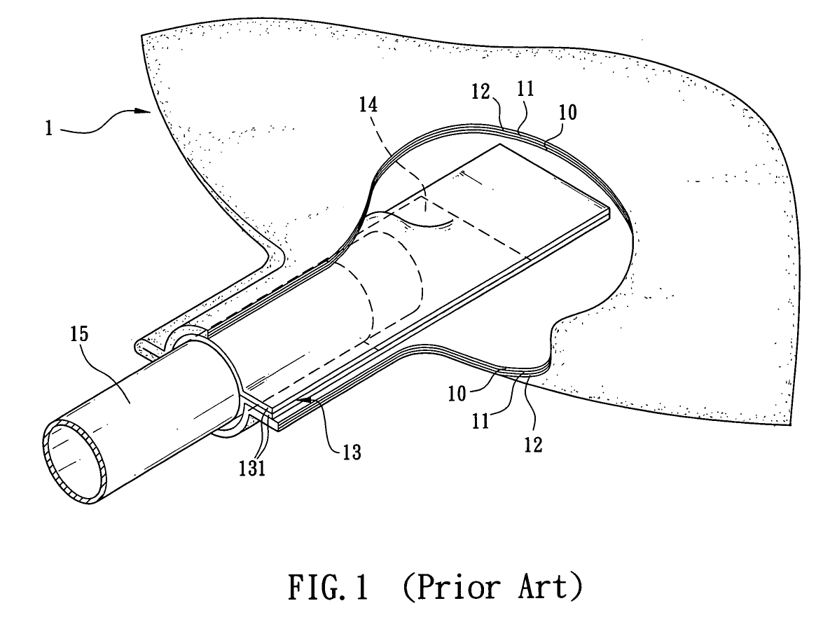

FIG. 2 is an exploded perspective view of a first preferred embodiment of support for a valve of an inflatable bag according to the invention;

FIG. 3 is a sectional view of the support of FIG. 2 mounted in the valve of the inflatable bag; and

FIG. 4 is a sectional, exploded view of a second preferred embodiment of support for a valve of an inflatable bag according to the invention.

### DETAILED DESCRIPTION OF THE PREFERRED EMBODIMENTS

The invention is directed to a support mountable in an inflatable bag. The support comprises a tube, at least two clamp members, and a tubelike support member. The tube is dimensioned and shaped to partially fit snugly into a belt shaped valve of the inflatable bag. An outer surface of the tube is formed with a first engagement member. The tube comprises a central first bore. Inner surfaces of the clamp members are dimensioned and shaped to fit snugly around an outer surface of the tube. At least one second engagement member is formed on the inner surface of either clamp member. The first engagement member is engaged with the second engagement members when the inner surfaces of the clamp members are urged against the outer surface of the tube. A half flared support element is formed at one end of the clamp member. The support member is dimensioned and shaped to fit snugly around the outer surfaces of the clamp members. As an end, the outer surface of the tube is tightly gripped by the clamp members.

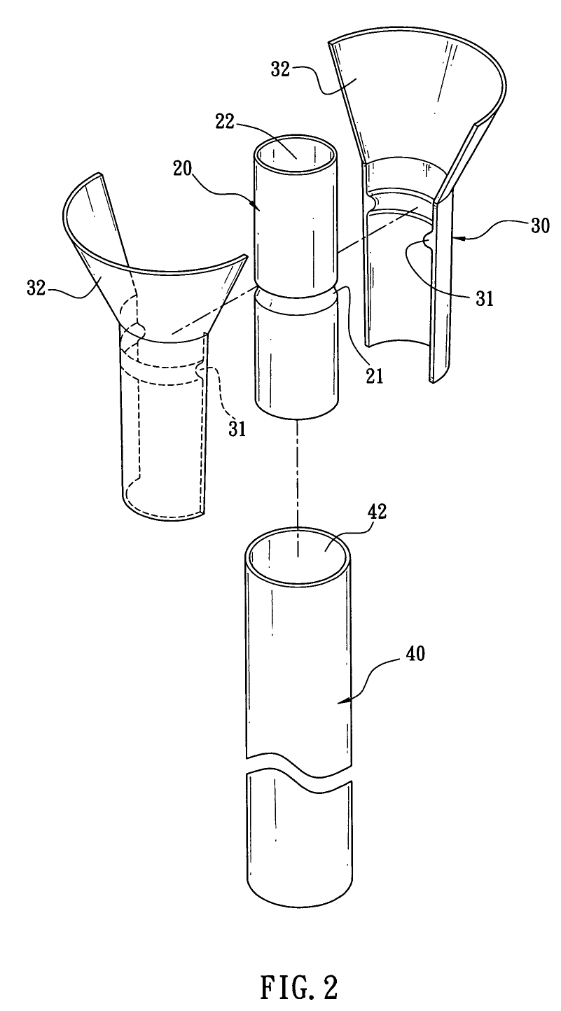

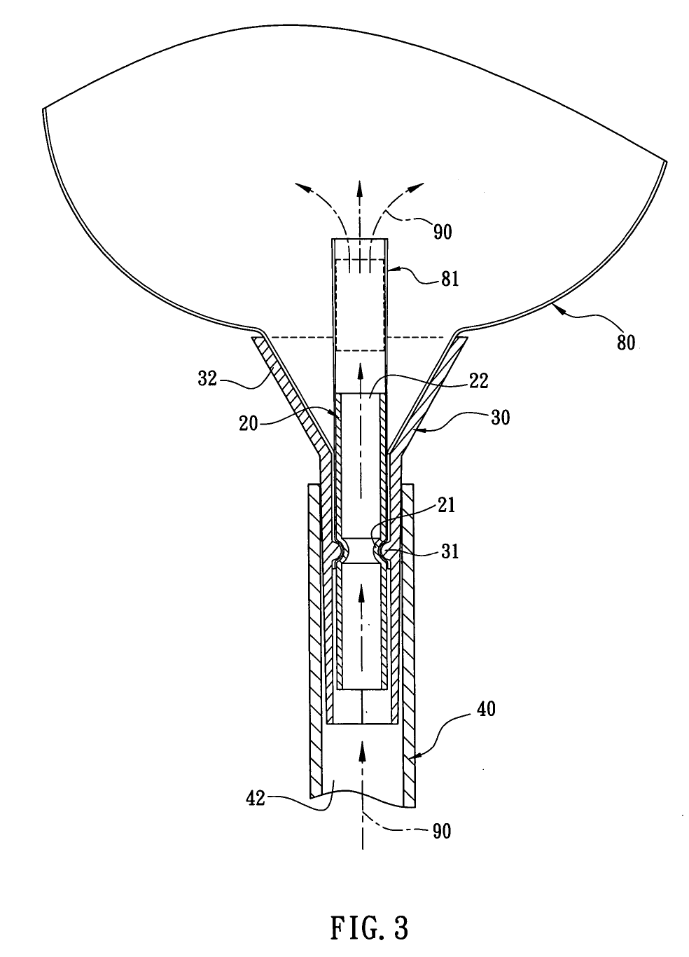

Referring to FIGS. 2 and 3, a support for the valve of the inflatable bag in accordance with a first preferred embodiment of the invention comprises a tube 20, two clamp members 30, and a tubelike support member 40. The tube 20 has a cylindrical shape and is dimensioned and shaped to fit snugly into a belt shaped valve 81 of an inflatable bag 80. An outer surface of the tube 20 is formed with a first engagement member 21. In the preferred embodiment, the first engagement member 21 is an annular groove. The tube 20 comprises a central first bore 22. In the preferred embodiment, the first bore 22 is a cylindrical hole. Inner surfaces of the clamp members 30 are dimensioned and shaped to fit snugly around an outer surface of the tube 20. The inner surface of the clamp member 30 has an arcuate section. A second engagement member 31 is formed on the inner surface of either clamp member 30. In the preferred embodiment, the second engagement member 31 is an arcuate rib 31. The rib 31 is dimensioned and shaped to fit snugly into the groove for engagement. That is, the first engagement member 21 is lockingly engaged with the second engagement members 31 when the inner surfaces of the clamp members 30 are urged against the outer surface of the tube 20. As an end, a peripheral edge of the belt shaped valve 81 is tightly gripped. A half flared support element 32 is formed at one end of the clamp member 30. A second bore 42 of the support member 40 is dimensioned and shaped to fit snugly around the outer surfaces of the clamp members 30. As an end, the peripheral edge of the belt shaped valve 81 is tightly gripped by the clamp members 30.

At this time, the other portion of the tube 20 is extended out of the belt shaped valve 81 and is disposed in the second bore 42 of the support member 40. After mounting the support in the belt shaped valve 81 of the inflatable bag 80, for example, a user may lift the other ends of the clamp members 30 distal the support member 40 and blow air thereinto in order to blow air into the inflatable bag 80. Next, air enters the inflatable bag 80 through the second bore 42 of the support member 40 having a large diameter, the tube 20, and the belt shaped valve 81 sequentially as indicated by arrows 90. The user may stop the blowing after the inflatable bag 80 has inflated to its full (i.e., a three-dimensional object is formed) by filling air therein. The other end of the belt shaped valve 81 distal the support will immediately return to its bonded, closed state. As a result, air inside the inflatable bag 80 is prevented from leaking via the belt shaped valve 81. Moreover, a flared opening formed by the support elements 32 will stably hold an outer surface of the support adjacent the inflatable bag 80 after the inflatable bag 80 has inflated to a three-dimensional object. As such, the inflated inflatable bag 80 will maintain in an upright position relative to the support. This is contrary to the prior art which after swelling may float obliquely after attaching to a post due to its own weight. As an end, the purpose of being used as a decoration is obtained by the invention.

It is noted that the above description is only a preferred embodiment of the invention. The invention is not limited to such in practice. Those skilled in the art may either modify the shape of the tube 20, the clamp members 30, the support member 40, or the support elements 32 or alter the number of the clamp members 30, the first engagement member 21, or the second engagement members 31 as taught by the characteristics of the above preferred embodiment as long as the embodied support is adapted to enable a user to easily blow air into the inflatable bag 80, enable the user to hold and stably support the inflatable bag 80 when it is swelled after the air filling, and maintain in an upright position thereafter due to the support. All of the above are within the scope of the invention to be protected.

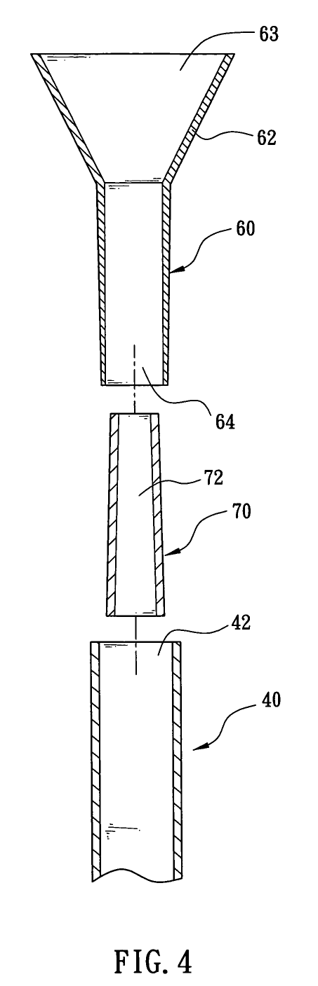

Referring to FIG. 4, a support for the valve of the inflatable bag in accordance with a second preferred embodiment of the invention comprises a support pipe 60, a tube 70, and a tubelike support member 40. The support pipe 60 is cylindrical. The support pipe 60 has one end extended and formed as a flared support element 62 and a central first bore 64. An inner diameter of the first bore 64 is dimensioned and shaped to fit snugly around a belt shaped valve extended from an inflatable bag by coupling. An inner diameter of the support pipe 60 is tapered away from the support element 62. The tube 70 is cylindrical and has an outer diameter dimensioned and shaped to have a portion thereof easily inserted into the belt shaped valve of the inflatable bag and into the first bore 64 of the support pipe 60 for fastening. As an end, a peripheral edge of the belt shaped valve of the inflatable bag is tightly gripped by and between the support pipe 60 and the tube 70. The tube 70 has a central third bore 72. The support member 40 has a central second bore 42. The second bore 42 is dimensioned and shaped to fit snugly around an outer surface of the support pipe 60.

In the second preferred embodiment of the invention the other end of the tube 70 is extended out of the belt shaped valve (i.e., exposed to the belt shaped valve) and is disposed in the second bore 42 of the support member 40. After mounting the support in the belt shaped valve of the inflatable bag, for example, a user may lift the other end of the support pipe 60 distal the support member 40 and blow air thereinto. Next, air enters the inflatable bag through the second bore 42 of the support member 40 having a large diameter, the third bore 72 of the tube 70, and the belt shaped valve sequentially. The user may stop the blowing after the inflatable bag has inflated to its full by filling air therein. The other end of the belt shaped valve distal the support will immediately return to its bonded, closed state. As a result, air inside the inflatable bag is prevented from leaking via the belt shaped valve. Also, a flared opening formed by the support element 62 will stably hold the inflatable bag. As such, the inflated inflatable bag will maintain in an upright position relative to the support. As an end, the purpose of being used as a decoration is obtained by the invention.

While the invention herein disclosed has been described by means of specific embodiments, numerous modifications and variations could be made thereto by those skilled in the art without departing from the scope and spirit of the invention set forth in the claims.

What is claimed is:

1. A support mountable in an inflatable bag having a belt shaped valve, comprising:
a tube having, an outer diameter dimensioned and shaped to partially fit into the belt shaped valve of the inflatable bag, the tube including a first engagement member formed on its outer surface, and a central first bore;
at least two clamp members each having an inner surface dimensioned and shaped to fit around the outer surface of the tube, each clamp member including a half flared support element extended from one end, and a second engagement member formed on its inner surface wherein the second engagement members are securely engaged with the first engagement member for gripping a peripheral edge of the belt shaped valve when the inner surfaces of the clamp members are urged against the outer surface of the tube; and
a tubelike support member including a central second bore dimensioned and shaped to fit around outer surfaces of the clamp members to cause the clamp members to grip the peripheral edge of the belt shaped valve.

2. The support of claim 1, wherein the first engagement member is an annular groove.

3. The support of claim 2, wherein each of the second engagement members is an arcuate rib dimensioned and shaped to fit snugly into the groove for engagement.

4. The support of claim 1, wherein each of the second engagement member is an annular groove.

5. The support of claim 4, wherein the first engagement member is an arcuate rib dimensioned and shaped to fit snugly into the groove for engagement.

6. A support mountable in an inflatable bag having a belt shaped valve extended therefrom, comprising:
a support pipe including a flared support element extended and formed at one end, and a central first bore having an inner diameter dimensioned and shaped to fit around the belt shaped valve of the inflatable bag by coupling wherein an inner diameter of the support pipe is tapered away from the support element;
a tube having an outer diameter dimensioned and shaped to partially fit into the belt shaped valve of the inflatable bag and into the first bore of the support pipe for fastening, thereby gripping a peripheral edge of the belt shaped valve of the inflatable bag between the support pipe and the tube, the tube including a central third bore; and
a tubelike support member including a central second bore dimensioned and shaped to fit around an outer surface of the support pipe for fastening.
